(19) United States
(12) Patent Application Publication
(10) Pub. No.: US 2006/0185880 A1
(43) Pub. Date: Aug. 24, 2006

(54) Chassis base assembly and plasma display panel assembly including the same

(76) Inventor: Dong-Hyok Shin, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/361,940

(22) Filed: Feb. 23, 2006

(30) Foreign Application Priority Data
Feb. 24, 2005 (KR) 10-2005-0015369

(51) Int. Cl. H02G 3/08

(52) U.S. Cl. 174/50

(57) ABSTRACT

A chassis base assembly and a plasma display panel assembly including the same are disclosed. In one embodiment, the chassis base assembly includes a chassis base coupled to a panel assembly displaying images, a bracket installed on an outer surface of the chassis base and including coupling portions and driving circuit units coupled to the coupling portions and transmitting electric signals to the panel assembly via flexible printed cables. According to one embodiment, the coupling portions having the insertion recesses, into which the driving circuit unit is fixedly inserted, are formed on the bracket attached on the chassis base, and thus, the structure of the chassis base assembly can be simplified.

### CROSS-REFERENCE TO RELATED PATENT APPLICATIONS

This application claims the benefit of Korean Patent Application No. 10-2005-0015369, filed on Feb. 24, 2005, in the Korean Intellectual Property Office, the disclosure of which is incorporated herein in its entirety by reference.

### BACKGROUND OF THE INVENTION

1. Field of the Invention

The present invention relates to a chassis base assembly having an improved coupling structure between a bracket installed on a surface of a chassis base and a driving circuit unit, and a plasma display panel assembly including the chassis base assembly.

2. Description of the Related Technology

In general, when a plasma display panel assembly is manufactured, a panel assembly is fabricated, a chassis base assembly is coupled to a rear portion of the panel assembly. Thereafter, a driving circuit unit is mounted on the chassis base assembly, and the panel assembly and the chassis base assembly are accommodated in a case.

A conventional chassis base assembly includes a chassis base, a plurality of brackets attached on an outer surface of the chassis base, and a driving circuit unit transmitting electric signals to the panel assembly.

The brackets are formed of a metal material such as an aluminum alloy in order to reinforce the chassis base, and attached as strips along a horizontal direction or a vertical direction of the chassis base. A plurality of the driving circuit units are installed in empty spaces between the brackets. The brackets and the driving circuit units are fixed onto the chassis via coupling units such as bosses.

Recently, in order to improve the assembling property of the chassis base assembly, brackets are integrally formed in a horizontal or a vertical direction.

### SUMMARY OF CERTAIN INVENTIVE ASPECTS

One aspect of the present invention provides a chassis base assembly in which brackets are installed on an outer surface of a chassis base and driving circuit units and flexible printed cables can be coupled to the bracket, and a plasma display panel assembly including the chassis base assembly.

Another aspect of the present invention provides a chassis base assembly including: a chassis base coupled to a panel assembly displaying images, a bracket installed on an outer surface of the chassis base, and including coupling portions, and driving circuit units coupled to the coupling portions, and transmitting electric signals to the panel assembly using flexible printed cables.

In one embodiment, the bracket may include a plurality of strips disposed in a horizontal direction and a vertical direction of the chassis base.

In one embodiment, each of the coupling portions may protrude a predetermined length from a side wall of the bracket, and may include an insertion recess into which an edge of the driving circuit unit is inserted.

In one embodiment, the edge of the driving circuit unit may be forcibly inserted and fixed into the insertion recess.

In one embodiment, the coupling portion may be an insertion recess formed in the side wall of the bracket.

In one embodiment, the bracket may be formed of a material having an elastic force.

In one embodiment, the bracket may include a plurality of clamping portions to which wires of the flexible printed cable can be fixed.

Another aspect of the present invention provides a plasma display panel assembly including: a panel assembly including a front panel and a rear panel facing the front panel, and displaying an image in response to a predetermined voltage, a chassis base assembly including a chassis base coupled to the panel assembly, a bracket installed on an outer surface of the chassis base and including coupling portions, and driving circuit units coupled to the coupling portions and transmitting electric signals to the panel assembly using flexible printed cables and a case accommodating the panel assembly and the chassis base assembly.

In one embodiment, the bracket may include a plurality of strips disposed in a horizontal direction and a vertical direction of the chassis base.

In one embodiment, at least a part of the horizontal bracket and at least a part of the vertical bracket may be integrally connected to each other.

In one embodiment, each of the coupling portions may protrude a predetermined length from a side wall of the bracket, and may include an insertion recess into which an edge of the driving circuit unit is inserted.

In one embodiment, the coupling portion may be an insertion recess formed in the side wall of the bracket, and the edge of the driving circuit unit may be forcibly inserted and fixed into the insertion recess.

In one embodiment, the bracket may include a plurality of clamping portions to which wires of the flexible printed cable can be fixed.

### BRIEF DESCRIPTION OF THE DRAWINGS

Embodiments of the present invention will become more apparent by describing in detail exemplary embodiments thereof with reference to the attached drawings.

FIG. 1 is an exploded perspective view of a plasma display panel assembly according to an embodiment of the present invention.

FIG. 2 is a perspective view of a chassis base assembly of FIG. 1, according to an embodiment of the present invention.

FIG. 3 is a perspective view of a portion A where a coupling unit is installed in FIG. 2.

FIG. 4 is a perspective view of a portion B where a clamping portion is formed in FIG. 2.

### DETAILED DESCRIPTION OF CERTAIN INVENTIVE EMBODIMENTS

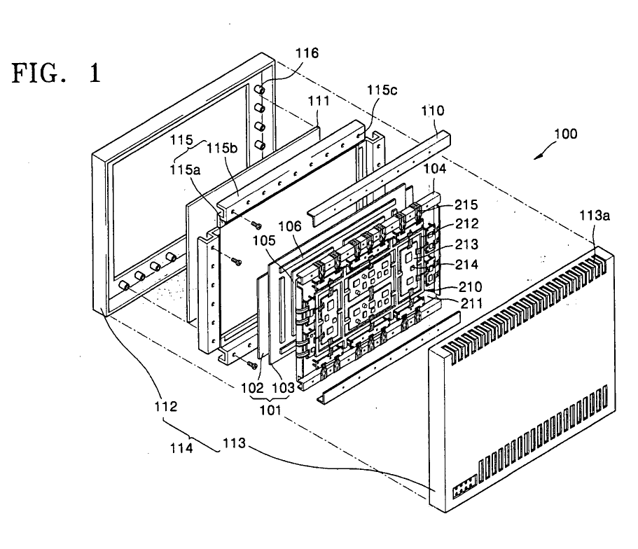

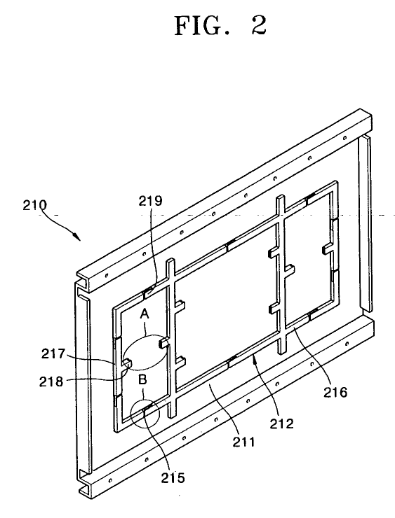

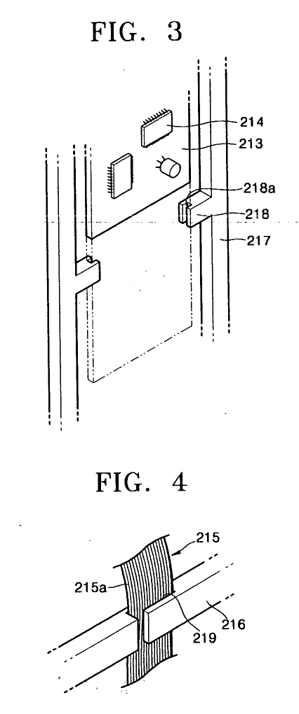

FIG. 1 is an exploded perspective view of a plasma display panel assembly 100 according to an embodiment of the present invention, and FIG. 2 is a perspective view of a chassis base assembly of FIG. 1, according to an embodiment of the present invention. FIG. 3 is a perspective view of a portion A where a coupling unit is installed in FIG. 2, and FIG. 4 is a perspective view of a portion B where a clamping portion is formed in FIG. 2.

Referring to FIG. 1, the plasma display panel assembly 100 includes a panel assembly 101 having a front panel 102 and a rear panel 103 facing the front panel 102. A frit glass (not shown) is applied onto edges of a space between the front panel 102 and the rear panel 103 to seal the inner space between the front panel 102 and the rear panel 103.

A chassis base assembly 210 (see FIG. 2) is generally disposed on a rear portion of the panel assembly 101. The chassis base assembly 210 includes a chassis base 211, a bracket 212, driving circuit units 213 (see FIG. 3) coupled to the bracket 212, and flexible printed cables 215 (see FIG. 4) electrically connecting the panel assembly 101 and the driving circuit units 213.

In one embodiment, the chassis base 211 is coupled to the panel assembly 101 by an adhesive unit. In one embodiment, the adhesive unit includes a heat radiation sheet 105 attached on a center portion of a rear surface of the rear panel 103, and dual-adhesive tapes 106 adhered on edges of the heat radiation sheet 105. The heat radiation sheet 105 can radiate the heat generated from the panel assembly 101 to the outside.

A plurality of circuit elements 214 are mounted on each of the driving circuit units 213, and each of the flexible printed cables 215 is respectively connected between each electrode terminal of the panel assembly 101 and the driving circuit unit 213 to transmit electric signals therebetween.

A filter assembly 111 is installed on a front portion of the panel assembly 101. The filter assembly 111 shields electromagnetic waves or ultraviolet radiation generated from the panel assembly 101, and prevents external light from being reflected by the plasma display panel when the plasma display panel is driven.

The panel assembly 101, the chassis base assembly 210, and the filter assembly 111 are accommodated in the case 114. The case 114 includes a front cabinet 112 installed on a front portion of the filter assembly 111, and back cover 113 installed on a rear portion of the chassis base assembly 210. Vent holes 113a are formed in upper and lower ends of the back cover 113.

In addition, a filter holder 115 is installed on a rear surface of the filter assembly 111. The filter holder 115 includes press portions 115a pressing the filter assembly 111 toward the front cabinet 112, and fixing portions 115b bent from the press portion 115a toward the panel assembly 101. The fixing portions 115b include a plurality of coupling holes 115c, respectively.

In addition, a plurality of filter mounting portions 116 are installed on rear edges of the front cabinet 112. The fixing portions 115b correspond to filter mounting portions 116, and they fix the filter assembly 115 on the front cabinet 112 using, for example, screws.

In one embodiment, the bracket 212 is installed on the rear surface of the chassis base 211. In another embodiment, the bracket 212 could be formed into the chassis base 211. In one embodiment, the driving circuit units 213 are fixedly inserted into the bracket 212 using a coupling unit, and the flexible printed cables 215 are fixed on the bracket 212.

Referring to FIG. 2, the chassis base assembly 210 includes the chassis base 211 coupled to the panel assembly 101 (refer to FIG. 1). In one embodiment, the chassis base 211 is a plane plate.

The bracket 212 is installed on the rear surface of the chassis base 211 in order to reinforce the chassis base 211. The bracket 212 includes strips, that is, horizontal bracket portions 216 disposed in a horizontal direction of the chassis base 211 and vertical bracket portions 217 disposed in a vertical direction of the chassis base 211. In one embodiment, the horizontal bracket portions 216 and the vertical bracket portions 217 are disposed on portions of the chassis base 211 which are to be reinforced and are connected to each other integrally.

In one embodiment, the bracket 212 includes coupling portions 218 for coupling the driving circuit units 213 thereto. In one embodiment, the bracket 213 includes clamping portions 219 into which the flexible printed cables 215 are fixedly inserted. In one embodiment, at least one of the horizontal bracket portion 216 and the vertical bracket portion 217 is coupled to the driving circuit unit 213 as shown in FIG. 3.

Referring to FIG. 3, in one embodiment, vertical bracket portions 217 are disposed to face each other. In one embodiment, coupling portions 218 of predetermined lengths protrude from inner walls of the vertical bracket portions 217. The coupling portions 218 extend from the vertical bracket portions 217 toward the edges of the driving circuit unit 213. In one embodiment, an insertion recess 218a is formed on an end portion of each coupling portion 218. In one embodiment, the edge of the driving circuit unit 213 can be forcibly inserted into the insertion recess 218a. Accordingly, the driving circuit unit 213 can be moved up and down to set the location thereof in a state where the edge portion of the driving circuit unit 213 is inserted in the insertion recess 218a.

In one embodiment, the horizontal bracket portion 216 or the vertical bracket portion 217 may be formed of a composite material or a plastic material so as to elastically support the driving circuit unit 213 when the driving circuit unit 213 is fixedly inserted into the insertion recess 218a. In another embodiment, the horizontal and vertical bracket portions 216 and 217 may be formed of other material such as metal.

In another embodiment, a recess may be formed in an inner wall of the horizontal bracket portion 216 or the vertical bracket portion 217 without extending the coupling portion 218 from the horizontal or vertical bracket portions 216 or 217, and the driving circuit unit 213 can be forcibly inserted into the recess.

FIG. 4 illustrates a structure in which the flexible printed cable 215 is fixed on the bracket 212.

In one embodiment, as shown in FIG. 4, a clamping portion 219 is formed by cutting a part of the horizontal bracket portion 216. In one embodiment, the clamping portion 219 is formed by forming a recess in a thickness direction or a length direction of the horizontal bracket portion 216. In one embodiment, a plurality of clamping portions 219 can be formed on the vertical bracket portion 217, as well as on the horizontal bracket portion 216. In one embodiment, wires 215a of the flexible printed cable 215 are fixedly inserted into the horizontal bracket portion 216.

The Process of fabricating the chassis base assembly 210 is as follows.

First, a plane plate for forming the chassis base 211 is prepared, and then, cut into a size appropriate for being coupled to the panel assembly 101.

In addition, the bracket 212 attached onto the rear surface of the chassis base 211 is formed using the composite material or the plastic material. The bracket 212 includes the horizontal and vertical bracket portions 216 and 217 that are connected to each other in the horizontal direction or the vertical direction of the chassis base 211, Also, each of the horizontal bracket portions 216 and each of the vertical bracket portions 217 are formed as strips.

The coupling portions 218 having predetermined lengths extend from the inner walls of the horizontal and vertical bracket portions 216 and 217. The insertion recesses 218a are formed on the end portions of the coupling portions 218. At the same time, a plurality of clamping portions 219 of a recess shape are formed on the horizontal and vertical bracket portions 216 and 217.

The bracket 212 can be firmly fixed on the outer surface of the chassis base 211 using, for example, a rivet or a screw.

In addition, the driving circuit unit 213 is disposed on the coupling portions 218 protruding from the inner walls of the horizontal and vertical bracket portions 216 and 217, and edges of the driving circuit unit 213 are forcibly inserted into the insertion recesses 218a of the coupling portions 218 to set the location of the driving circuit unit 213.

The wires 215a of the flexible printed cable 215 electrically connecting the driving circuit unit 213 to each electrode terminal of the panel assembly 101 are fixedly inserted into the clamping portion 219 formed on the horizontal bracket portion 216 or the vertical bracket portion 217.

According to one embodiment of the present invention, the coupling portions having the insertion recesses, into which the driving circuit unit is fixedly inserted, are formed on the bracket attached on the chassis base, and thus, the structure of the chassis base assembly can be simplified.

In addition, since the flexible printed cables are fixedly inserted into the clamping portions of the bracket, they can be easily fixed on the bracket.

Also, the coupling portions and the clamping portions are simultaneously formed on the bracket, and thus, the fabrication processes is simple and fabrication costs are reduced.

Furthermore, the horizontal bracket portion and the vertical bracket portion are formed on the portions of the chassis base which have weak strengths, and thus, the chassis base can be reinforced.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A chassis base assembly, comprising:
a chassis base, having first and second surfaces, wherein the second surface oppose the first surface, and wherein the first surface of the chassis base is configured to be coupled to a panel assembly which is configured to display images; and
a bracket on the second surface of the chassis base, wherein the bracket includes a plurality of coupling portions;
wherein the plurality of coupling portions are configured to couple to a plurality of driving circuit units, respectively, and wherein each of the plurality of driving circuit units is configured to transmit electric signals to the panel assembly via at least one cable.

2. The chassis base assembly of claim 1, wherein the bracket includes a plurality of strips formed in a horizontal direction and a vertical direction of the chassis base.

3. The chassis base assembly of claim 2, wherein each of the coupling portions protrudes a predetermined length from a side wall of the bracket, and includes an insertion recess into which an edge of a respective driving circuit unit is inserted.

4. The chassis base assembly of claim 3, wherein an edge of the driving circuit unit is configured to be forcibly inserted and fixed into the insertion recess.

5. The chassis base assembly of claim 2, wherein each of the coupling portions is an insertion recess formed in a side wall of the bracket.

6. The chassis base assembly of claim 5, additionally comprising a plurality of driving circuit units and wherein an edge of a respective driving circuit unit is configured to be forcibly inserted into the insertion recess to be fixed.

7. The chassis base assembly of claim 2, wherein the bracket is formed from at least one of the following: i) a material having an elastic force, ii) a composite material and iii) a plastic material.

8. The chassis base assembly of claim 3, wherein the plurality of coupling portions include at least a pair of opposing coupling portions, and wherein two opposing edges of a driving circuit unit may be fixed into the insertion recesses of the pair of the coupling portions.

9. The chassis base assembly of claim 1, wherein the at least one cable is a flexible printed cable and wherein the bracket includes a plurality of clamping portions to which wires of the at least one flexible printed cable can be fixed.

10. The chassis base assembly of claim 9, wherein each of the clamping portions includes a recess through which the wires are fixedly inserted.

11. A plasma display panel assembly, comprising:
a panel assembly including a front panel and a rear panel facing the front panel, and configured to display an image;
a chassis base assembly including i) a chassis base coupled to the panel assembly, ii) a bracket installed on a surface of the chassis base and including coupling portions, and iii) a plurality of driving circuit units coupled to the coupling portions and transmitting electric signals to the panel assembly via at least one flexible printed cable; and
a case accommodating the panel assembly and the chassis base assembly.

12. The plasma display panel assembly of claim 11, wherein the bracket includes a plurality of strips formed in a horizontal direction and a vertical direction of the chassis base.

13. The plasma display panel assembly of claim 12, wherein at least a part of the horizontal bracket and at least a part of the vertical bracket are integrally connected to each other.

14. The plasma display panel assembly of claim 12, wherein each of the coupling portions protrudes a predetermined length from a side wall of the bracket, and includes an insertion recess into which an edge of a respective driving circuit unit is inserted.

15. The plasma display panel assembly of claim 12, wherein each of the coupling portions is an insertion recess formed in a side wall of the bracket, and an edge of a respective driving circuit unit is configured to be forcibly inserted and fixed into the insertion recess.

16. The plasma display panel assembly of claim 11, wherein the bracket is formed from at least one of the following: i) an elastic material, ii) a composite material and iii) a plastic material.

17. The plasma display panel assembly of claim 12, wherein the plurality of coupling portions include at least a pair of opposing coupling portions, and wherein two opposing edges of a driving circuit unit are fixed into the insertion recesses of the pair of the coupling portions.

18. The plasma display panel assembly of claim 11, wherein the bracket includes a plurality of clamping portions to which wires of the at least one flexible printed cable are configured to be fixed.

19. The plasma display panel assembly of claim 18, wherein each of the clamping portions includes a recess through which the wires are fixedly inserted.

20. A chassis base assembly, comprising:
a chassis base, having first and second surfaces opposing the first surface, wherein the first surface of the chassis base is coupled to a panel assembly which is configured to display images; and
a bracket on the second surface of the chassis base, wherein the bracket includes a plurality of clamping portions, and wherein each of the plurality of clamping portions is configured to clamp a portion of at least one cable electrically connecting at least one driving circuit unit and the panel assembly.
